(19) United States
(12) Patent Application Publication
(10) Pub. No.: US 2014/0265055 A1
(43) Pub. Date: Sep. 18, 2014

(54) HOLLOW BOX WITH IDENTIFICATION MEMBER AND DEVICE FOR MAKING THE SAME

(71) Applicants: CHIEN-MIN HSIAO, TAICHUNG CITY (TW); JUI-FENG HSIEH, TAICHUNG CITY (TW)

(72) Inventors: CHIEN-MIN HSIAO, TAICHUNG CITY (TW); JUI-FENG HSIEH, TAICHUNG CITY (TW)

(21) Appl. No.: 13/844,811

(22) Filed: Mar. 16, 2013

(51) Int. Cl. B29D 22/00

(52) U.S. Cl. CPC B29D 22/003
USPC 264/526; 425/504

(57) ABSTRACT

A method for making a hollow box includes a step of cutting a plate into identification members; a step of sucking the plate to be attached on a fixed area of a female mold by a suction device; a step of squeezing melting and semi-solidified thermo-plastic material and sealing a lower end of the melting and semi-solidified thermo-plastic material, the melting and semi-solidified thermo-plastic material being expanded by the air introduced therein; a step of clamping the melting and semi-solidified thermo-plastic material by a female mold and a male mold; a step of expanding the melting and semi-solidified thermo-plastic material until the melting and semi-solidified thermo-plastic material contacts against insides of the female and male molds; a step of melting the surface of the identification member which is connected to the hollow box; a step of cooling obtaining the product by separating the female and male molds.

### FIELD OF THE INVENTION

The present invention relates to a hollow box with an identification member formed thereon, and more particularly, to a hollow box with an identification member formed thereon and a device for making the same.

### BACKGROUND OF THE INVENTION

A conventional method for making a hollow air blow molding box comprises a step (A), wherein the melting and semi-solidified material is squeezed from a material supply device. Air is introduced into the melting and semi-solidified material to seal the lower end of the material so that the enclosed material is expanded by the air.

A step (B), wherein the expanded material is clamped by the female mold and the male mold so that the expanded material is cut by the female and male molds.

A step (C), wherein an injection tube on the male mold is inserted into the expanded material and air is continuously introduced into the expanded material until the material is completely matched against the insides of the female and male molds.

A step (D), wherein the expanded material is cooled by the cooling paths in the mold set and the material becomes to be solidified.

A step (E), wherein the female and male molds are separated to pick the hollow box.

However, the conventional hollow box is made by a single color PE and the logo and specifications are simultaneously formed on the surface of the box. The customers cannot immediately identify the box because there is only one color available.

In order to improve the shortcoming mentioned above, the manufacturers use post machining to print the logo, trademark and specification on the box by another color. Nevertheless, the printed material is easily removed and scratched away.

Furthermore, when the printing area has ridges protruding therefrom, the surface between the ridges is difficult to be printed by the conventional methods. Taiwan Utility Patent No. M397891 discloses a method for connecting artificial or natural leather with expanded and melting material. Nevertheless, the shrink rates for the two different materials are different so that lumps will be formed at the boundary areas of the two materials and this will be treated as a defect. The products with flaws cannot be reused and the manufacturing cost is therefore increased.

### SUMMARY OF THE INVENTION

The present invention relates to a method for making a hollow box and includes a step of cutting a plate into identification members; a step of sucking one plate to be attached on a fixed area of a female mold by a suction device; a step of squeezing melting and semi-solidified thermo-plastic material from a material supply device and a lower end of the melting and semi-solidified thermo-plastic material being sealed, the melting and semi-solidified thermo-plastic material being expanded by the air introduced therein; a step of clamping the melting and semi-solidified thermo-plastic material by a female mold and a male mold; a step of using an injection tube to expand the melting and semi-solidified thermo-plastic material until the melting and semi-solidified thermo-plastic material contacts against insides of the female and male molds; a step of surface melting to melt the identification member which is connected to the melting and semi-solidified thermo-plastic material; a step of cooling the hollow box, and a step of obtaining the product by separating the female and male molds.

The primary object of the present invention is to provide a method for making a hollow box with an identification layer which has different color from the box.

Another object of the present invention is to provide a device for making a hollow box with an identification layer which has different color from the box.

Yet another object of the present invention is to provide a device for making a hollow box with an identification layer wherein the material of the identification layer is the same as the hollow box so that the yield rate is reduced.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hollow box and the device of the present invention;

FIG. 2 is a top view to show the hollow box of the present invention;

FIG. 3 shows the cross sectional view taken along line A-A in FIG. 2;

FIG. 4 is a cross sectional view to show the steps of the method in FIG. 3 of the present invention;

FIG. 5 is a cross sectional view to show the steps of the method in FIG. 4 of the present invention;

FIG. 6 is a cross sectional view to show the completion of the steps of the method in FIG. 5 of the present invention, and

FIG. 7 is a perspective view to show the hollow box made by the method and the device of the present invention.

### DETAILED DESCRIPTION OF THE PREFERRED EMBODIMENT

Referring to FIGS. 1 to 7, the method for making a hollow box of the present invention comprises a step (A) cutting: cutting the elastic and extendable plate 1 into identification members 10 of pre-set shape. Multiple identification holes 11 are defined through the identification members 10, the identification holes 11 are characters, numbers or patterns. The plate 1 is made by the same material as the thermo-plastic material 8 which is PP, PE, PET, or a mixture of PP and PE. The defective products can be re-cycled and reused to reduce the manufacturing cost. The plate 1 has a thickness of 0.05 mm to 0.3 mm, the plate 1 is in a scrolled form or an elongate plate.

A step (B) of sucking a plate 1: activating a suction device 6 which is located at the suction path 22 of the fixing area 21 of a female mold 2. An elastic, extendable and air non-permeable plate 1 is sucked to be attached on the fixed area 21 of the female mold 2 by the air streams from the suction hole 220, and the identification member 1 is matched with the curvature of the inside of the fixed area 21. The female mold 2 has at least one recessed area 20 for receiving the thermo-plastic material 8. The fixing area 21 is formed at the proper position of the recessed area 20. The fixing area 21 has one or more than one suction holes 22. As shown in FIG. 1, the fixing area 21 is the recessed area 20 or an enclosed and recessed area defined by a ridge 211, or a recessed area 20 located between two symmetric ridges 211, or a recessed area (not shown) defined by a U-shaped ridge 211. The fixing area 21 has a recess 213 as shown in FIG. 1.

The suction path 22 provides a path for the air communicating between the inside of the fixing area 21 and the suction path 22. The suction path 22 has a suction hole 220 and a pipe 223 which is fixed to the suction hole 220, or the suction path 22 has a suction hole 220 and a connector 222 which is fixed to the suction hole 220, and a pipe 223 is fixed to the connector 222, or the suction path 22 has a suction hole 220 and a chamber 221 which is fixed to the suction hole 220, and a pipe 223 is fixed to the chamber 221, or the suction path 22 has a suction hole 220 and a chamber 221 which is fixed to the suction hole 220, and a connector 222 is connected to the chamber 221 and a pipe 223 is connected to the connector 222, or the suction path 22 has a suction hole 220 and a chamber 221 which is fixed to the suction hole 220, a cover 5 seals the chamber 222 and a pipe 223 is connected to a locking hole 52 of the cover 5, or the suction path 22 has a suction hole 220 and a chamber 221 which is fixed to the suction hole 220, a cover 5 seals the chamber 222 and a connector 222 and a pipe 223 is connected to the connector 222 as shown in FIG. 1. The free end of the chamber 221 is fixed to a threaded hole 23 of the female mold 2 by extending a bolt 25 through a through hole 51 of the cover 5 and connected to the threaded hole 23 to make the cover 5 seal the free end of the chamber 221. A seal member 7 is located between the cover 5 and the chamber 221, the periphery of the free end of the chamber 221 is air-tightly in contact with the cover 5.

The suction device 6 is a suction machine and has a housing 60, an air inlet 61, an air exit 62, a rotor (not shown), a stator (not shown) and a fan unit (not shown). When the suction device 6 is activated, the air in the fixing are 21 of the female mold 2 is sucked to the suction path 22 and leaves from the air exit 62. The elastic, extendable and air non-permeable plate 1 is moved to the fixing area 21 and the identification member 10 is sucked by the sucking air flow and is matched with the curvature of the inside of the fixed area 21.

A step (C) of putting material: squeezing melting and semi-solidified thermo-plastic material 8 from a material supply device (not shown). Air is introduced into the melting and semi-solidified thermo-plastic material 8. The lower end of the melting and semi-solidified thermo-plastic material 8 is sealed so that the melting and semi-solidified thermo-plastic material 8 is expanded by the air introduced therein as shown in FIG. 4.

A step (D) of clamping: the melting and semi-solidified thermo-plastic material 8 being snugly clamped between the female mold 2 and the male mold 3. The cutting portion 32 of the male mold 3 is engaged with the blade 24 of the female mold 2 to cut the expanded thermo-plastic material 8 which is enclosed between the female and male molds 3, 2 as shown in FIG. 5.

A step (E) of air introducing: an injection tube 35 on the inner mold 30 of the male mold 3 being inserted into the melting and semi-solidified thermo-plastic material 8. Air is introduced into the thermo-plastic material 8 to expand the thermo-plastic material 8 until the thermo-plastic material 8 contacts against insides of the female and male molds 2, 3. The thermo-plastic material 8 fills into the recess 213 as shown in FIG. 5.

A step (F) of surface melting: the melting and semi-solidified thermo-plastic material 8 being moved to an identification member 10 by pressure. The surface of the identification member 10 on the melting and semi-solidified thermo-plastic material 8 is melted and connected to the melting and semi-solidified thermo-plastic material 8. The melting and semi-solidified thermo-plastic material 8 also extends toward the recess 213 and the identification member 10 extends toward the recess 213 until the identification member 10 is completely matched with the insides of the female and male molds 2, 3. The identification member 10 is partially protruded by the pressure of the melting and semi-solidified thermo-plastic material 8 in the recess 213 as shown in FIG. 5.

A step (G) of cooling: a hollow box “A” being cooled and solidified by cooling paths in the female and male molds 2, 3.

A step (G) obtaining product: separating the female and male molds 2, 3 to pick up the hollow box “A” by using the push board (not shown) on the male mold 3. The hollow box with the identification member 10 is removed from the female and male molds 2, 3 as shown in FIG. 6. The identification member 10 is formed on the highest surface of the hollow box “A”, or on the second highest surface of the hollow box “A”, or on the top surface of an area between two decoration ridges A1 as shown in FIG. 7.

The characters of the present invention are that there are multiple suction paths 22 in the fixing area 21 of the female mold 2 so that the air flows between the fixing area 21 and the suction device 6. The elastic, extendable and air non-permeable plate 1 or identification member 10 is sucked to be attached on the fixed area 21 of the female mold 2 by the air streams from the suction paths 22. By this way, the plate 1 does not move by the squeezing force of the melting and semi-solidified thermo-plastic material 8. The surface of the plate 1 is melted by the contact with the melting and semi-solidified thermo-plastic material 8. The plate 1 extends along with the extension of the melting and semi-solidified thermo-plastic material 8 in the recess 213 to ensure that the plate 1 is securely connected with the expanded thermo-plastic material 8. This improves the shortcoming of the conventional method. The identification member 10 is located on the highest surface of the hollow box “A”, or on the second highest surface of the hollow box “A”, or on the top surface of an area between two decoration ridges A1, so that the identification member 10 is prevented from dropping or scratching.

The plate 1 is made by the same material as the thermo-plastic material 8 which is PP, PE, PET, or a mixture of PP and PE. The defective products can be re-cycled and reused to reduce the manufacturing cost.

While we have shown and described the embodiment in accordance with the present invention, it should be clear to those skilled in the art that further embodiments may be made without departing from the scope of the present invention.

What is claimed is:

1. A method for making a hollow box, comprising:
a step (A) of sucking a plate: a plate being sucked to be attached on a fixed area of a female mold by a suction device via a suction path in the fixed area of the female mold;
a step (B) of putting material: squeezing melting and semi-solidified thermo-plastic material from a material supply device, air being introduced into the melting and semi-solidified thermo-plastic material, a lower end of the melting and semi-solidified thermo-plastic material being sealed so that the melting and semi-solidified thermo-plastic material is expanded by the air introduced therein;
a step (C) of clamping: the melting and semi-solidified thermo-plastic material 8 being snugly clamped between a female mold and a male mold;
a step (D) of air introducing: an injection tube on an inner mold of the male mold being inserted into the melting and semi-solidified thermo-plastic material and air being introduced into the melting and semi-solidified thermo-plastic material to expand the melting and semi-solidified thermo-plastic material until the melting and semi-solidified thermo-plastic material contacts against insides of the female and male molds;
a step (E) of surface melting: the melting and semi-solidified thermo-plastic material being moved to an identification member by pressure and a surface of the plate on the melting and semi-solidified thermo-plastic material being melted and connected to the melting and semi-solidified thermo-plastic material so as to form a hollow box;
a step (F) of cooling: the hollow box being cooled and solidified by cooling paths in the female and male molds, and
a step (G) of obtaining product: separating the female and male molds to pick up the hollow box which has an identification layer formed on the hollow box, the identification layer being composed by the plate, the identification layer formed on a highest surface of the hollow box, or on a second highest surface of the hollow box, or on a top surface of an area between two ridges.

2. The method as claimed in claim 1, wherein a step of cutting is proceeded before the step (A), the elastic, extendable and air non-permeable plate is cut into pieces, the plate has a thickness of 0.05 mm to 0.3 mm, the plate is in a scrolled form or an elongate plate, the plate is made by the same material as the thermo-plastic material which is PP, PE, PET, or a mixture of PP and PE.

3. A device for making a hollow box, comprising:
a female mold having a fixed area which has a recessed area for receiving thermo-plastic material therein, a suction path located in the fixed area;
a suction device having a suction unit and having an air inlet, an air exit, a rotor, a stator and a fan unit, and
an elastic, extendable and air non-permeable plate being sucked on an inside of the fixing area of the female mold such that an identification layer with the plate on a top surface thereof is formed on a highest surface of the hollow box, or on a second highest surface of the hollow box, or on a top surface of an area between two decoration ridges.

4. The device as claimed in claim 3, wherein the suction path has a suction hole and a pipe which is fixed to the suction hole.

5. The device as claimed in claim 3, wherein the suction path has a suction hole and a connector which is fixed to the suction hole, a pipe is fixed to the connector.

6. The device as claimed in claim 3, wherein the suction path has a suction hole and a connector which is fixed to the suction hole, a pipe is fixed to the connector.

7. The device as claimed in claim 3, wherein the suction path has a suction hole and a chamber which is fixed to the suction hole, a pipe is fixed to the chamber.

8. The device as claimed in claim 3, wherein the suction path has a suction hole and a chamber which is fixed to the suction hole, a cover seals the chamber and a pipe is connected to a locking hole of the cover.

9. The device as claimed in claim 3, wherein the suction path has a suction hole and a chamber which is fixed to the suction hole, a cover seals the chamber 222 and a connector is connected to a locking hole of the cover, a pipe is connected to the connector.

10. The device as claimed in claim 8, wherein a free end of the chamber is fixed to a threaded hole of the female mold by extending a bolt through a through hole of the cover and connected to the threaded hole, the cover seals the free end of the chamber, a seal member is located between the cover and the chamber, a periphery of the free end of the chamber is air-tightly in contact with the cover.

11. The device as claimed in claim 9, wherein a free end of the chamber is fixed to a threaded hole of the female mold by extending a bolt through a through hole of the cover and connected to the threaded hole, the cover seals the free end of the chamber, a seal member is located between the cover and the chamber, a periphery of the free end of the chamber is air-tightly in contact with the cover.

12. The device as claimed in claim 3, wherein the fixing area is the recessed area or an enclosed and recessed area defined by a ridge, or a recessed area located between two symmetric ridges, or a recessed area defined by a U-shaped ridge.

13. The device as claimed in claim 4, wherein the fixing area is the recessed area or an enclosed and recessed area defined by a ridge, or a recessed area located between two symmetric ridges, or a recessed area defined by a U-shaped ridge.

14. The device as claimed in claim 5, wherein the fixing area is the recessed area or an enclosed and recessed area defined by a ridge, or a recessed area located between two symmetric ridges, or a recessed area defined by a U-shaped ridge.

15. The device as claimed in claim 6, wherein the fixing area is the recessed area or an enclosed and recessed area defined by a ridge, or a recessed area located between two symmetric ridges, or a recessed area defined by a U-shaped ridge.

16. The device as claimed in claim 7, wherein the fixing area is the recessed area or an enclosed and recessed area defined by a ridge, or a recessed area located between two symmetric ridges, or a recessed area defined by a U-shaped ridge.

17. The device as claimed in claim 8, wherein the fixing area is the recessed area or an enclosed and recessed area defined by a ridge, or a recessed area located between two symmetric ridges, or a recessed area defined by a U-shaped ridge.

18. The device as claimed in claim 9, wherein the fixing area is the recessed area or an enclosed and recessed area defined by a ridge, or a recessed area located between two symmetric ridges, or a recessed area defined by a U-shaped ridge.

19. The device as claimed in claim 3, wherein the plate 1 is made by the same material as the thermo-plastic material which is PP, PE, PET, or a mixture of PP and PE, the plate has a thickness of 0.05 mm to 0.3 mm, the plate is in a scrolled form or an elongate plate, the plate is an elastic, extendable and air non-permeable plate which is cut into identification members, identification holes are defined through the identification members, the identification holes are characters, numbers or patterns, the thermo-plastic material is squeezed into the identification holes to have different color from the identification members.
